(19) United States
(12) Patent Application Publication
(10) Pub. No.: US 2020/0283163 A1
(43) Pub. Date: Sep. 10, 2020

(54) FLIGHT VISION SYSTEM AND METHOD FOR PRESENTING IMAGES FROM THE SURROUNDING OF AN AIRBORNE VEHICLE IN A FLIGHT VISION SYSTEM

(71) Applicant: SAAB AB, Linkoeping (SE)

(72) Inventor: Stefan BLOM, Saltsjoebaden (SE)

(21) Appl. No.: 16/765,514

(22) PCT Filed: Dec. 14, 2017
(86) PCT No.: PCT/SE2017/051277

§ 371 Date: May 20, 2020

(51) Int. Cl. B64D 43/00; G06K 9/03; G06K 9/00; B64D 47/08; G01C 23/00

(52) U.S. Cl. CPC B64D 43/00; G06K 9/036; G01C 23/005; B64D 47/08; G06K 9/0063

(57) ABSTRACT

The present disclosure relates to a method (300) for presenting images from the surrounding of an airborne vehicle in a flight vision system. The method comprises the step of providing (310) a plurality of images of the surrounding of the airborne vehicle. The plurality of images originates from at least two different sources. The method further comprises assessing (320) a quality measure in each of the images out of the plurality of images. The quality measure relates at least to the visibility of objects in the plurality of images. The method even further comprises automatically deciding (330) from which of the at least two different sources at least one image out of the plurality of images should be displayed. The decision is based at least on the assessed quality measure. The method yet even further comprises displaying (340) the at least one automatically decided image in the flight vision system. The present disclosure also relates to a flight vision system, an airborne vehicle, a computer program product and a computer-readable storage medium.

### TECHNICAL FIELD

The present disclosure relates to a flight vision system and to a method for presenting images from the surrounding of an airborne vehicle in a flight vision system. It further relates to a computer program product, to a computer-readable storage medium, and to an airborne vehicle.

### BACKGROUND ART

In flight vision systems, information regarding the surrounding of an airborne vehicle is presented to an observer. This information can originate from different sources, such as different sensors. The different sources usually have different properties. As an example, a first source might be able to provide high resolved images, but it not able to provide long range images during rain and/or fog. A second source might be able to provide long range images during rain and/or fog, but the provided images might be only low-resolved. When having access to different sources in the flight vision system, it is thus important to decide in a good way which of the sources should be used to provide images for flight vision system. In the above example, it might be a good choice to show images from the second source in case it is raining and/or foggy and in case the airborne vehicle is at long distance from a place to land, such as an airfield. If, on the other hand, there is no rain and/or fog or in case the airborne vehicle is close to a place to land, it might be a good choice to show images from the first sensor.

Often, one of two different ways is applied how to choose between different sources. One way is to switch between different sources is based on a distance to a place to land, such as a distance to a runway. As an example, when the airborne vehicle is situated closer than a pre-determined threshold from the runway, images from a first source are used in the flight vision system. In case the airborne vehicle is situated longer than the pre-determined threshold from the runway, images from a second source are used. This has the disadvantage that no consideration is given to the weather conditions. Since the threshold is pre-determined irrespective of the weather, the choice of sources to use for the flight vision system will usually not be optimal for all weather conditions.

This disadvantage has been solved by another way, relying on so-called runway visual range, RVR. A RVR-system might be installed at an airport and determine repeatedly the visibility from the runway. As an example, the RVR-system might repeatedly determine that the runway is visible from a certain distance. Since this determination is repeated, the determined distance might change in each run. Thus, consideration to the weather conditions can be given by a RVR-system. The determined distance is then transmitted from the RVR-system to the airborne vehicle and the source can be switched in the flight vision system of the airborne vehicle based on the determined distance. Although consideration to the weather is given, this way of switching between different sources has the disadvantage that it requires an installation of the RVR-system at the airport, or at any other place to land. Thus, this solution requires quite some resources and preparation. Therefore, RCR-systems are usually not installed at smaller airports and airborne vehicles thus do not always have the advantages of an RVR-system.

### SUMMARY OF THE INVENTION

It is an objective of the present disclosure to present a flight vision system, an airborne vehicle, a method, a computer program product, and a computer-readable storage medium which alleviate at least some of the above mentioned disadvantages.

It is a further objective of the present disclosure to present a flight vision system, an airborne vehicle, a method, a computer program product, and a computer-readable storage medium which provide an alternative solution to the hitherto known flight vision systems.

It is yet a further objective of the present disclosure to present a flight vision system, an airborne vehicle, a method, a computer program product, and a computer-readable storage medium which present an optimal image to an observer.

It is yet even a further objective of the present disclosure to present a flight vision system, an airborne vehicle, a method, a computer program product, and a computer-readable storage medium which require a low amount of human interaction during operation to present an optimal image to an observer.

At least some of the aforementioned objectives are achieved by a method for presenting images from the surrounding of an airborne vehicle in a flight vision system. The method comprises the step of providing a plurality of images of the surrounding of the airborne vehicle. The plurality of images originates from at least two different sources. The method further comprises assessing a quality measure in each of the images out of the plurality of images. The quality measure relates at least to the visibility of objects in the plurality of images. The method further comprises to automatically deciding from which of the at least two different sources at least one image out of the plurality of images should be displayed. The decision is based at least on the assessed quality measure. The method yet even further comprises displaying the at least one automatically decided image in the flight vision system.

This has the advantage that no extra equipment at the airport, such as an RVR-system is required. Further, no input from the operator of the airborne vehicle is required. The method can automatically adapt the flight vision system to the best possible view given the circumstances, such as the current weather conditions. It is in this relation not needed to know the weather conditions, as the method will automatically adapt to it. Since no extra equipment outside the airborne vehicle is required, the autonomous degree of the airborne vehicle can be increased. As a consequence, flexibility can be increased, and cost an needed pre-investments be reduced.

In one example, the step of assessing a quality measure comprises comparing images from different sources for finding differences between the images. This is a simple way of assessing a quality measure.

In one example, the step of assessing a quality measure comprises determining a qualitative measure for each of the images out of the plurality of images. This allows to have a specific expression for the quality.

In one example, at least one of the at least two different sources is a database, for example a database for synthetic vision. This allows for an applicability of the system even under bad weather conditions.

In one example, at least one of the at least two different sources is an image sensor.

In one example, the image sensor is an infrared sensor, a radar sensor, and/or a sensor for visual wavelengths. This allows using known sensors and gives good flexibility to adapt to different weather conditions.

In one example, the step of assessing a quality measure comprises comparing each image out of the plurality of images with a pre-determined pattern. This allows to easily detect objects of specific importance, such as runways.

In one example, the step of automatically deciding from which of the at least two different sources at least one image out of the plurality of images should be displayed comprises choosing only one out of the at least two different sources. This reduced latency and computation power.

In one example, the step of automatically deciding from which of the at least two different sources at least one image out of the plurality of images should be displayed comprises choosing a plurality out of the at least two different sources. This allows to maximise the information on the display since different information/objects from different sources can be combined.

At least some of the objectives are also achieved by a flight vision system for presenting images from the surrounding of an airborne vehicle. The flight vision system is arranged to receive a plurality of images of the surrounding of the airborne vehicle from at least two different sources. The flight vision system comprises a processor arrangement which is arranged to assess a quality measure in each of the images out of the plurality of images. The quality measure relates at least to the visibility of objects in the plurality of images. The processor arrangement is further arranged to automatically decide from which of the at least two different sources at least one image out of the plurality of images should be displayed. The decision is based at least on the assessed quality measure. The flight vision system also comprises at least one display which is arranged to display the at least one automatically decided image.

In one embodiment the processor arrangement is arranged to compare images from different sources for finding differences between the images.

In one embodiment the processor arrangement is arranged to determine a qualitative measure for each of the images out of the plurality of images.

In one embodiment, the flight vision system is further arranged to receive images from at least one database. At least one of the at least two different sources is a database, for example a database for synthetic vision.

In one embodiment, the flight vision system is further arranged to receive images from at least one image sensor. At least one of the at least two different sources is an image sensor.

In one embodiment, the image sensor is an infrared sensor, a radar sensor, and/or a sensor for visual wavelengths.

In one embodiment, the processor arrangement is arranged to compare each image out of the plurality of images with a pre-determined pattern.

In one embodiment, the processor arrangement is arranged to choose only one out of the at least two different sources when automatically deciding from which of the at least two different sources at least one image out of the plurality of images should be displayed.

In one embodiment, the processor arrangement is arranged to choose a plurality out of the at least two different sources when automatically deciding from which of the at least two different sources at least one image out of the plurality of images should be displayed.

At least some of the objectives are also achieved by a computer program product, comprising instructions which, when the program is executed by a computer, cause the computer to carry out the method according to the present disclosure.

At least some of the objectives are also achieved by a computer-readable storage medium comprising instructions which, when executed by a computer, cause the computer to carry out the method according to the present disclosure.

At least some of the objectives are also achieved by an airborne vehicle which comprises the flight vision system according to the present disclosure.

In relation to this disclosure the term computer can relate to what is commonly referred to as a computer and/or to an electronic control unit.

The system, the airborne vehicle, the computer program product and the computer-readable storage medium have corresponding advantages as have been described in connection with the corresponding examples of the method according to this disclosure.

Further advantages of the present invention are described in the following detailed description and/or will arise to a person skilled in the art when performing the invention.

### BRIEF DESCRIPTION OF THE DRAWINGS

For a more detailed understanding of the present invention and its objects and advantages, reference is made to the following detailed description which should be read together with the accompanying drawings. Same reference numbers refer to same components in the different figures. In the following,

FIG. 1 shows, in a schematic way, an airborne vehicle according to one embodiment of the present disclosure;

FIG. 2 shows, in a schematic way, a flight vision system according to an embodiment of the present disclosure;

FIG. 3 shows, in a schematic way, a method according to an example of the present invention; and

FIG. 4 shows, in a schematic way, an example of a situation in which the present disclosure can be used.

### DETAILED DESCRIPTION

The term “link” refers herein to a communication link which may be a physical connection such as an opto-electronic communication line, or a non-physical connection such as a wireless connection, e.g. a radio link or microwave link.

The term “image” does not require a lifelike picture. Instead, the term “image” comprises also wrong-coloured images, stylised images, and the like.

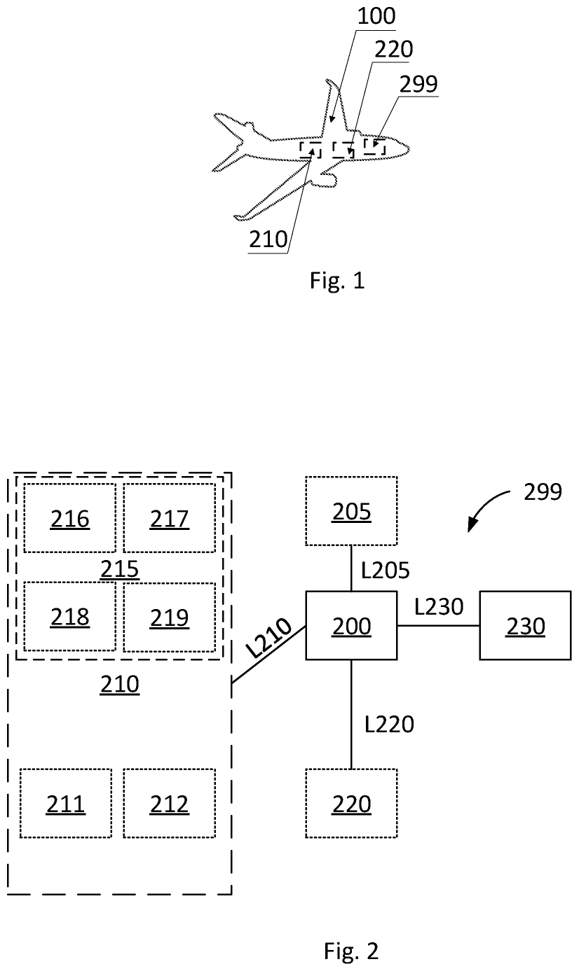

FIG. 1 shows, in a schematic way, an airborne vehicle 100 according to one embodiment of the present disclosure. The airborne vehicle 100 can be any kind of aircraft, such as an airplane, a helicopter, an airship, or the like. The airborne vehicle 100 can be manned or unmanned. The airborne vehicle can comprise a flight vision system 299, which is described in more detail in relation to FIG. 2. The airborne vehicle 100 can comprise any of the sources 210, 220 described in relation to FIG. 2.

FIG. 2 shows, in a schematic way, a flight vision system 299 according to an embodiment of the present disclosure. The flight vision system 299 can be a so-called enhanced flight vision system, EFVS. However, any other type of flight vision system might be used as well. The flight vision system 299 is arranged to present images from the surrounding of an airborne vehicle.

The flight vision system 299 comprises a processor arrangement. The processor arrangement comprises at least one processor. The processor arrangement can comprise a first control unit 200 and/or a second control unit 205. In the following, an embodiment of the invention will be described based on the first and/or second control unit 200. 205. However, it should be understood that the anything attributed to the first and/or second control unit 200, 205 equally well can be applied to any other processor arrangement.

The flight vision system 200 can be connected to different image sources. In the following, two different kinds of image sources 210 and 220 are discussed. However, it should be emphasised that the present disclosure can be adapted to any other kind of image source as well. In one example, the flight vision system 299 is connected to at least one database 220. The database 220 can be any database arranged to provide images of the surrounding of the airborne vehicle. In one example, the database 220 is a database for synthetic vision, SV. As an example, the database 200 can contain two-, or three-dimensional terrain data regarding the surrounding of the airborne vehicle. The database can contain images of the surrounding of the airborne vehicles and/or contain texture information of the terrain data.

The first control unit 200 can be connected to the database 220 via a link L220. The database 220 is arranged for communication with the first control unit 200, for example via the link L220. The database 220 is arranged to transmit images of the surrounding of the airborne vehicle. The first control unit 200 is arranged to receive the images from the database 220. In one example, the database 220 is arranged to store the images. In one example, the database 220 comprises processing means, such as at least one processor, which are arranged to produce the images out of data from the database.

In one example, the flight vision system 200 is connected to at least one image sensor, such as at least one image sensor out of a sensor array 210. In the following, an embodiment of the disclosure is described in relation to the sensor array 210. However, it should be understood that the sensor array in its simplest form comprises only one image sensor. The sensor array 210 can comprise a radar sensor 211. The radar sensor 211 can be arranged to provide radar images of the surrounding of the airborne vehicle. The sensor array 210 can comprise a sensor for visible light 212, such as a camera. The sensor for visible light 212 can be arranged to provide images of the visible spectrum of the surrounding of the airborne vehicle. The sensor array 210 can comprise an IR sensor array 215. The IR sensor array 215 can comprise any number of IR sensors, such as a near IR sensor 216, a short-wavelength IR sensor 217, a mid-wavelength IR sensor 218, and/or a long-wavelength IR sensor 219. The sensor(s) in the IR sensor array can be arranged to provide a respective and/or a combined IR image of the surrounding of the airborne vehicle. It is well known in the art how any of the sensors described in relation to the sensor array 210 can provide respective images. Therefore, this is not described any further here.

The first control unit 200 can be connected to the sensor array 210, and/or any of the sensors therein, via a link L210. The sensor array 210, and/or any of the sensors therein, is arranged for communication with the first control unit 200, for example via the link L220. The sensor array 210, and/or any of the sensors therein, is arranged to transmit images of the surrounding of the airborne vehicle. The first control unit 200 is arranged to receive the images from the sensor array 210, and/or any of the sensors therein.

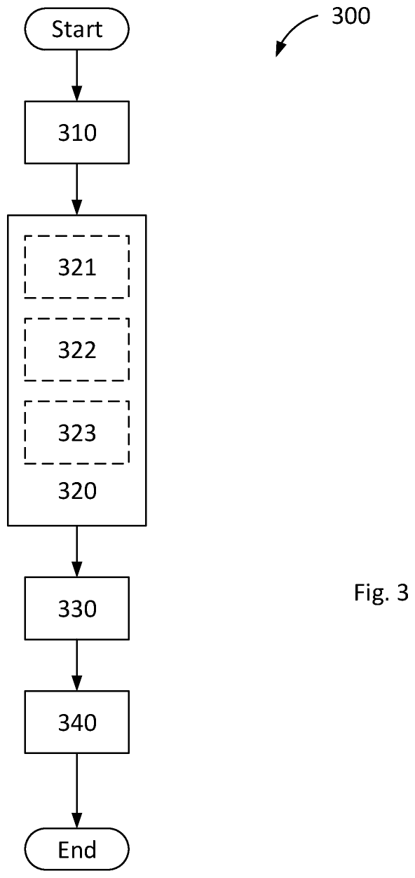

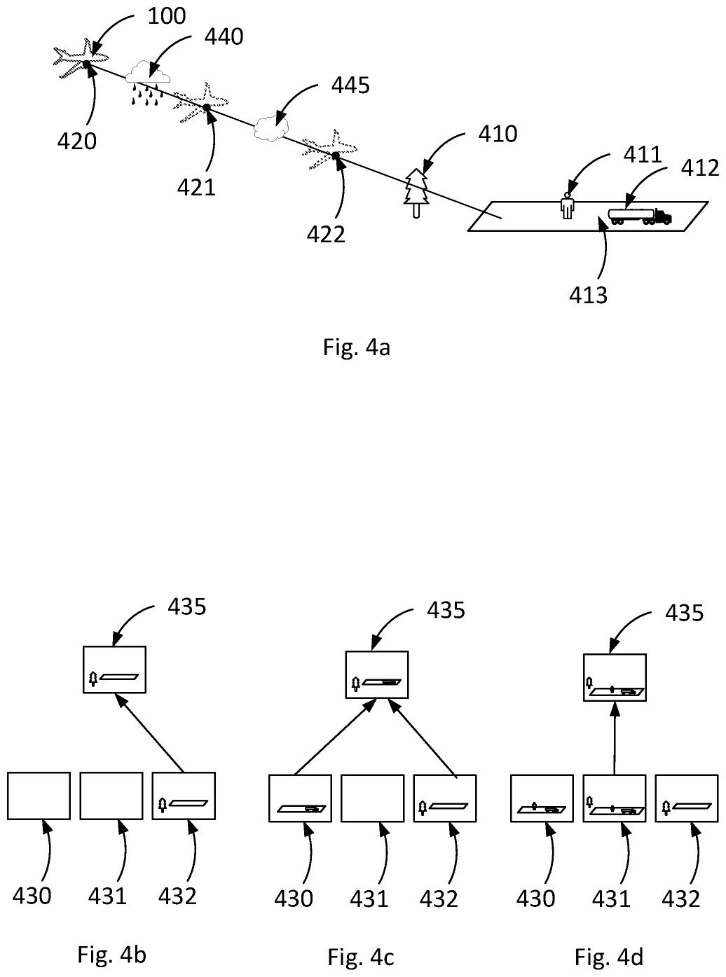

The first control unit 200 is arranged to assess a quality measure in each of the images received from the database 220, the sensor array 210, or from any other source. The quality measure relates at least to the visibility of objects in the received images. The assessing of the quality measure is described in more detail in relation to FIG. 3. In one example, the first control unit 200 is arranged to compare images from different sources for finding differences between the images. In one example, the first control unit 200 is arranged to determine a qualitative measure for each of the images out of the plurality of images. Examples of how a comparison and/or a qualitative measure can be performed are described in relation to FIGS. 3 and 4.

The first control unit 200 is further arranged to automatically decide from which of the different sources, such as the database 220, any of the images sensors in the sensor array 210, or any other source, at least one image out of the plurality of images should be displayed. The first control unit 200 is arranged to base the decision at least on the assessed quality measure. This is also further explained in relation to FIGS. 3 and 4. As an example, the first control unit 200 may be arranged to compare each image out of the plurality of images with a pre-determined pattern. This is further explained in relation to FIGS. 3 and 4 as well.

In one example, the first control unit 200 is arranged to choose only one out of the different sources, such as only one of the images sensors in the sensor array 210, or only the database 220. This is especially useful in case it can be determined that this only one source provides an image of better quality in any respect. In one example, the first control unit 200 is arranged to choose a plurality out of the at least two different sources, such as a plurality of the image sensors in the sensor array 210 and possibly the database 220, or such as only one of the image sensors in the sensor array 210 and the database 220. This is especially useful in case it can be determined that at least one first source has a better quality in one respect and that at least one second source has a better quality in another respect.

The flight vision system 299 comprises at least one display 230. The at least one display is, for example, a head up display, HUD, and/or a head down display, HDD. The first control unit 200 can be connected to the at least one display 230 via a link L230. The first control unit 200 is arranged for communication with the at least one display 230, for example via the link L230. The first control unit 200 can be arranged to transmit at least one image to the at least one display 230. The at least one image comprises at least the automatically decided image. The at least one display 230 is arranged to display the at least one automatically decided image.

A second control unit 205 might be arranged for communication with the first control unit 200 via a link L205. It may be a control unit external to the airborne vehicle 100. It may be adapted to conducting the innovative method steps according to the invention. The second control unit 205 may be arranged to perform the inventive method steps according to the invention. It may be arranged for communication with the first control unit 200 via an internal network on board the airborne vehicle. It may be adapted to performing substantially the same functions as the first control unit 200, such as controlling any of the elements of the system 299. The innovative method may be conducted by the first control unit 200 or the second control unit 205, or by both of them.

FIG. 3 shows, in a schematic way, a method 300 according to an example of the present invention. The method 300 is a method for presenting images from the surrounding of an airborne vehicle in a flight vision system. The method 300 starts with the step 310.

Step 310 comprises providing a plurality of images of the surrounding of the airborne vehicle. The plurality of images originates from at least two different sources. In one example, at least one of the at least two different sources is a database, for example a database for synthetic vision. An example of such a database has been described in relation to FIG. 2. In one example, at least one of the at least two different sources is an image sensor. Examples of such image sensors have been discussed in relation to FIG. 2 and can, for example, be an infrared sensor, a radar sensor, and/or a sensor for visual wavelengths. The at least two different sources can be sources which differ by the wavelength of the spectrum which they detect. The method continues with step 320.

In step 320 a quality measure is assessed in each of the images out of the plurality of images which have been provided in step 310. The quality measure relates at least to the visibility of objects in the plurality of images. It should be emphasised that the term visibility in relation to step 320 does not relate to any specific wavelength of the light. In that respect, the term visibility relates to the fact that objects can be identified as being objects, i.e. that they are not covered by fog, rain, or the like, in the respective image. In one example, step 320 comprises step 321.

In step 321, a qualitative measure is determined for each of the images out of the plurality of images which have been provided in step 310. The determined qualitative measure can then be the assessed quality measure. In principle, any qualitative measure relating at least to the visibility can be used. Examples of such qualitative measures are known in the art. As an example, the qualitative measure can be a measure relating to the contrast in each of the images. In practice, images not disclosing objects have usually low contrast. As an example, an image only showing fog will in general have low contrast. On the other side, in practice, images disclosing objects, i.e. images where objects are visible, do often have in comparison high contrast as the contours of the objects will contribute to the contrast.

In one example, step 320 comprises step 322. In step 322, images from different sources are compared. This comparison is performed for finding differences between the images. As an example, the differences can relate to the presence of objects in the images. The comparison can be performed for determining whether objects are present in at least one of the images which are not present in at least one other of the images, and/or vice versa. It should be understood that different cases are possible. In a first example, one image out of the plurality of images shows all the objects which can be detected in the plurality of images. In a second example, a first image out of the plurality of images shows at least one first object which is not shown in a second images out of the plurality of images, whereas the second image shows at least one second object which is not shown in the first image. Such an example is discussed in more detail in relation to FIG. 4. The assessed quality measure might relate to the number and/or the kind and/or properties of visible objects in a respective image. The properties of the visible objects might, for example, relate to anyone of size, distance, velocity, position, temperature, or any other property of the object.

In one example, step 320 comprises step 323. In step 323 each image out of the plurality of images is compared with a pre-determined pattern. The pre-determined pattern can be a pattern which is expected to be seen in an image. As an example, the light pattern at a runway is often standardised. Thus, when approaching a runway, it is expected that the pre-determined light pattern at some point of time will be present in any of the images. The assessed quality measure can then relate to the fact whether one, or several, pre-determined patterns are present at an image. As an example, it might be assessed that an image which shows the expected light pattern of the runway may have better quality than an image which does not show that pattern. A reason can be that the pilot of the vehicle is interested in seeing the runway whenever possible.

It should be understood that the assessed quality measure in step 320 is not necessarily a one-dimensional quantity. Instead, the quality measure can have different aspects and/or can be two- or more dimensional. As an example, a first image might have a better quality than a second image in one respect, but a better quality than the second image in another respect.

After step 320, the method 300 continues with step 330.

In step 330, it is automatically decided from which of the at least two different sources at least one image out of the plurality of images should be displayed. This decision is based at least on the assessed quality measure. As an example, in case it is determined that the images of a specific source show a specific pre-determined pattern, it might be decided that images from this source should be displayed. As an example, in case it is determined that the images of a specific source show objects which are not visible in the images from any other source, it might be decided that the images of this source should be displayed. As an example, in case it is determined that the images of a specific source show objects more clearly than the images from any other source, it might be decided that the images of this source should be displayed.

In one example, only one out of the at least two different sources is chosen to be displayed. This might, for example, be the case in case it is decided that images from this source have better quality than images from other sources in any respect. Another reason might be that it is decided that images from only one source should be displayed in any case. This might be advantageous to reduce complexity in computational power and/or to reduce latency in the system.

In one example, at least two different sources out of the plurality of sources are chosen to be displayed. This might, for example, be the case in case it is decided that images from a first source have better quality than images from a second sources in one respect, while it is vice versa in another respect. Then it can be decided that images from both sources are displayed. This has the advantage that more information will be available for an operator. On the other side, this usually requires to decide how the images from the different sources should be combined. As an example, it might be decided that the images from the different sources should be combined into a combined image. The combined image might be combined in such a way that all the objects which are visible by at least one of the sources can be seen in the combined image. The method continues with step 340.

In step 340, the at least one automatically decided image is displayed in the flight vision system. In one example, the at least one automatically decided image relates to the combined image from step 330. After step 340 the method 300 ends.

In a preferred embodiment, the method 300 is performed repeatedly. It should be emphasised that there is quite some freedom to define suitable quality measures. There is further quite some freedoms to define suitable rules which decide on which image should be displayed in the flight vision system, where the decision is based on the assessed quality measures. Both the quality measures and the rules might vary between different kinds of sources and might have to be adapted to the specific sources at hand in a given setup and/or to the specific properties of the airborne vehicles and/or the tasks to be performed by the airborne vehicle.

The present disclosure also relates to a computer program product and to a computer-readable storage medium. The computer program product and the computer-readable storage medium can comprise instructions which, when the program is executed by a computer, cause the computer to carry out the method 300. As an example, the execution might be performed on the system 299 described in relation to FIG. 2, for example on the first and/or second control unit 200, 205.

FIG. 4 shows, in a schematic way, an example of a situation in which the present disclosure can be used. In FIG. 4a, the overall situation is depicted. It should be emphasised that the figure is drawn to best explain the context of the present disclosure. The figure is not to scale.

An airborne vehicle 100 is approaching a runway 413. To start with, the airborne vehicle is at a first position 420 with a first distance to the runway. This situation is further described in relation to FIG. 4b. It then approaches the runway and will after some time be at a second position 421 with a second distance to the runway. This situation is further described in relation to FIG. 4c. When further approaching the runway, the airborne vehicle will reach a third position 422 with a third distance to the runway 413. This situation is further described in relation to FIG. 4d. A tree 410 is placed in between the position of the airborne vehicle 100 and the intended position to land on the runway 413. The tree 410 exemplifies a first object and can in principle be any other object or group of objects. On the runway 413, a person 411 is situated. The person 411 is an example of a second object or group of objects. It could equally well be larger animal such as a moose or the like, or any other object. A tank truck 412 is also placed on the runway 413. The tank truck 412 is an example of a third object or group of objects. It could be equally well any other object, such as any other vehicle. As can be seen from the example, it might be advantageous for an operator of the aircraft to detect any of the objects 410, 411, and 412 as early as possible as any of these objects might prevent a safe landing on the runway 413.

In the depicted situation, the airborne vehicle 100 is equipped with three sources: an infrared sensor, a sensor for visual wavelengths, and a database for synthetic vision. The infrared sensor provides a first image 430. The sensor for visual wavelengths provides a second image 431. The database for synthetic vision provides a third image 432.

Now the situation at the first, second, and third position 420, 421, 422 will be described in relation to FIGS. 4b, 4c, and 4d, respectively. In practice, the images at the three positions will not show the objects in the same size in all three positions as the scale will change when approaching the runway. However, this effect is not depicted as it would decrease legibility of the objects in the images at the first and the second position. The image which will be shown in the flight vision system is depicted a fourth image 435. It might be one of the first, second, or third image 430, 431, 432, or a combination thereof.

The database for synthetic vision might contain both the tree 410 and the runway 413 as they are stationary. The database for synthetic vision will, however, not contain the person 411 and the tank truck 412 as they are non-stationary objects and were not present at the time the database for synthetic vision was created. At all three positions 420, 421, and 422 the third image 432 from the database will show the tree 410 and the runway 413. This might be due to the fact that the database for synthetic vision usually does not change during the flight and that the database is usually not weather dependent.

At the first position 420, heavy rain clouds 440 are situated between the airborne vehicle and the runway. These heavy rain clouds 440 prevent both the sensor for visible wavelengths and the infrared sensor from providing any images disclosing objects. The images from these sensors might thus be quite blurred and with low contrast. As a consequence, none of the three objects 410, 411, and 412, and not the runway 413 either will be visible in the first and the second image 430 and 431 in FIG. 4b. As only one of the three images will show any of the objects, it will be assessed that the third image 432, i.e. the only image showing some objects, has best quality. It can then be decided that only this image should be displayed, i.e. that only the database for synthetic vision should provide images which are shown on the flight vision system. Thus, the fourth image 435 will be identical to the third image 432. This is indicated in FIG. 4b.

At the second position 421, there is no longer any rain between the airborne vehicle 100 and the runway. However, still clouds 445 are present between the second position 421 and the runway 413. As a consequence, still none of the three objects 410, 411, and 412, and neither the runway 413 will be visible in the second image 431. This is since the clouds 445 prevent light at visible wavelengths to penetrate them. Some infrared, IR, wavelengths, however, might penetrate the clouds 445. As a consequence, the runway 413 might be, at least indirectly, visible in the first image 430. As an example, the runway might be equipped with light sources forming a pre-determined light pattern and also emitting at IR-wavelengths which penetrate the clouds. At the airborne vehicle, the image from the IR sensor might be analysed to recognise pre-determined patterns and the light pattern of the runway 413 might be detected, and thus the runway 413. The tree 410 is not visible at the first images 430 since it is not emitting differently at IR-wavelengths compared to the surrounding of the tree. The person 411 is not visible on the first image 430. Although the person 411 will emit IR-radiation which differs from the surrounding, the IR-sensor might have limited resolution so that the person 411 will not be visible yet at the second position 421. The tank truck 412, however, might emit differently at IR-wavelengths from the surrounding and is of a big enough size to be visible on the first image.

It can then be assessed that the first and the third image are of better quality than the second image. In the third image 432, one object, i.e. the tree 410, is visible which is not visible in the first image 430. On the other hand, an object, i.e. the tank truck 412 is visible in the first image 430 which is not visible in the third image 432. Thus, it can be decided that both images from the IR sensor and from the database should be displayed. In the shown example, these images are combined and the combined image which is displayed, i.e. the fourth image 435, shows all objects which are visible in at least one of the first, second, and third images 430, 431, and 432.

At the third position 422, there are no clouds any longer between the airborne vehicle 100 and the runway. As a consequence, the sensor for visible wavelengths will be able to see all objects and thus all objects will be present in the second image 431. The first image 430 will be the same as in the second position 421, with the addition that the person 411 now also is visible due to the fact that the distance to the person is shorter so that the sensor can resolve the person. However, the tree 410 is still not visible in the first image since it does not emit IR-radiation differently than the surrounding of the tree. One image, i.e. the second image 431, shows all objects, whereas the first and the third image 430, 432 do not. It can thus be assessed that the second image 432 has best quality. As a consequence, it can be decided that the displayed image, i.e. the fourth image 435, corresponds to the second image 432.

Thus, depending on the position of the airborne vehicle and the weather conditions, images from different sources are displayed in the flight vision system. The sources change as the airborne vehicle approaches the runway. The decision which sources should be used for displaying does neither require input from an operator of the airborne vehicle, nor does it require any equipment at the airport such as a RVR-system, nor any information regarding the weather for proper functioning. Instead, the flight vision system adapts automatically so as to present an optimised image to the operator.

The situation described in relation to FIG. 4 is only an example. Other combinations of sensors and/or databases are possible. Which sources to choose might depend on the sources available aboard the airborne vehicle. As an example, a combination of a radar sensor, an infrared sensor and a database might be used as sources. Another example is a combination of a radar sensor, a visible sensor and a database. A third example is a combination of a radar sensor, an infrared sensor, a visible sensor, and possibly a database. The number of sources combined can be larger or smaller than three sources in the example of FIG. 4. When referring to an infrared sensor this might be an arbitrary infrared sensor. Examples of infrared sensors have been discussed in relation to the infrared sensor array 215.

It should especially be noted that the flight vision system according to the present disclosure can be arranged to perform any of the steps or actions described in relation to the method 300. It should also be understood that the method according to the present disclosure can further comprise any of the actions attributed to an element of the flight vision system 299 described in relation to FIG. 2. The same applies to the computer program product and the computer-readable storage medium.

### LIST OF ELEMENTS

100 Airborne vehicle
200 First control unit
205 Second control unit
210 Image sensor array
211 Radar sensor
212 Sensor for visible light
215 IR sensor array
216 Near IR sensor
217 Short-wavelength IR sensor
218 Mid-wavelength IR sensor
219 Long-wavelength IR sensor
220 Database
230 Display
299 Flight vision system
410 Tree
411 Person
412 Tank truck
413 Runway
420 First position
421 Second position
422 Third position
430 First image
431 Second image
432 Third image
435 Fourth image
440 Rain clouds
445 Clouds

1. A method (300) for presenting images from the surrounding of an airborne vehicle in a flight vision system, the method comprising the steps of:
providing (310) a plurality of images of the surrounding of the airborne vehicle, wherein the plurality of images originates from at least two different sources;
assessing (320) a quality measure in each of the images out of the plurality of images, wherein the quality measure relates at least to the visibility of objects in the plurality of images;
automatically deciding (330) from which of the at least two different sources at least one image out of the plurality of images should be displayed, wherein the decision is based at least on the assessed quality measure; and
displaying (340) the at least one automatically decided image in the flight vision system.

2. The method according to the claim 1, wherein the step of assessing a quality measure comprises comparing (322) images from different sources for finding differences between the images.

3. The method according to claim 1, wherein the step of assessing a quality measure comprises determining (321) a qualitative measure for each of the images out of the plurality of images.

4. The method according to claim 1, wherein at least one of the at least two different sources is a database, for example a database for synthetic vision.

5. The method according to claim 1, wherein at least one of the at least two different sources is an image sensor.

6. The method according claim 1, wherein the image sensor is an infrared sensor, a radar sensor, and/or a sensor for visual wavelengths.

7. The method according to claim 1, wherein the step of assessing a quality measure comprises comparing (323) each image out of the plurality of images with a pre-determined pattern.

8. The method according to claim 1, wherein the step of automatically deciding from which of the at least two different sources at least one image out of the plurality of images should be displayed comprises choosing only one out of the at least two different sources.

9. The method according to claim 1, wherein the step of automatically deciding from which of the at least two different sources at least one image out of the plurality of images should be displayed comprises choosing a plurality out of the at least two different sources.

10. A flight vision system (299) for presenting images from the surrounding of an airborne vehicle, the flight vision system being arranged to receive a plurality of images of the surrounding of the airborne vehicle from at least two different sources, the flight vision system comprising:
a processor arrangement (200; 205), being arranged to assess a quality measure in each of the images out of the plurality of images, wherein the quality measure relates at least to the visibility of objects in the plurality of images, and to automatically decide from which of the at least two different sources at least one image out of the plurality of images should be displayed, wherein the decision is based at least on the assessed quality measure; and
at least one display (230) being arranged to display the at least one automatically decided image.

11. The flight vision system according claim 1, wherein the processor arrangement is arranged to compare images from different sources for finding differences between the images.

12. The flight vision system according to claim 1, wherein the processor arrangement is arranged to determine a qualitative measure for each of the images out of the plurality of images.

13. The flight vision system according to claim 1, further being arranged to receive images from at least one database (220) and wherein at least one of the at least two different sources is a database, for example a database for synthetic vision.

14. The flight vision system according to claim 1, further being arranged to receive images from at least one image sensor (210), and wherein at least one of the at least two different sources is an image sensor.

15. The flight vision system according to claim 1, wherein the image sensor is an infrared sensor (216-219), a radar sensor (211), and/or a sensor (212) for visual wavelengths.

16. The flight vision system according to claim 1, wherein the processor arrangement is arranged to compare each image out of the plurality of images with a pre-determined pattern.

17. The flight vision system according to claim 1, wherein the processor arrangement is arranged to choose only one out of the at least two different sources when automatically deciding from which of the at least two different sources at least one image out of the plurality of images should be displayed.

18. The flight vision system according to claim 1, wherein the processor arrangement is arranged to choose a plurality out of the at least two different sources when automatically deciding from which of the at least two different sources at least one image out of the plurality of images should be displayed.

19. A computer program product, comprising instructions which, when the program is executed by a computer, cause the computer to carry out the method according to claim 1.

20. A computer-readable storage medium comprising instructions which, when executed by a computer, cause the computer to carry out the method according to anyone of claim 1.

21. An airborne vehicle (100), comprising the flight vision system (299) according claim 1.
